(19) United States
(12) Patent Application Publication
(10) Pub. No.: US 2008/0235705 A1
(43) Pub. Date: Sep. 25, 2008

(54) Methods and Apparatus for Global Systems Management

(75) Inventors: John Alan Bivens, Ossining, NY (US); David Michael Chess, Mohegan Lake, NY (US); Donna N. Dillenberger, Yorktown Heights, NY (US); Steven E. Froehlich, Danbury, CT (US); James Edwin Hanson, Yorktown Heights, NY (US); Mark Francis Hulber, New York, NY (US); Jeffrey Owen Kephart, Cortlandt Manor, NY (US); Giovanni Pacifici, New York, NY (US); Michael Joseph Spreitzer, Croton-on-Hudson, NY (US); Asser Nasreldin Tantawi, Somers, NY (US); Mathew S. Thoennes, West Harrison, NY (US); Ian Nicholas Whalley, Pawling, NY (US); Peter B. Yocom, Lagrangeville, NY (US)

Correspondence Address: RYAN, MASON & LEWIS, LLP, 90 FOREST AVENUE, LOCUST VALLEY, NY, 11560, US

(73) Assignee: International Business Machines Corporation, Armonk, NY (US)

(21) Appl. No.: 12/133,872

(22) Filed: Jun. 5, 2008

Related U.S. Application Data
(63) Continuation of application No. 11/486,927, filed on Jul. 14, 2006.
(60) Provisional application No. 60/699,215, filed on Jul. 14, 2005.

(51) Int. Cl. G06F 9/46

(52) U.S. Cl. 718/105

(57) ABSTRACT

Techniques for globally managing systems are provided. One or more measurable effects of at least one hypothetical action to achieve a management goal are determined at a first system manager. The one or more measurable effects are sent from the first system manager to a second system manager. At the second system manager, one or more procedural actions to achieve the management goal are determined in response to the one or more received measurable effects. The one or more procedural actions are executed to achieve the management goal.

### CROSS-REFERENCE TO RELATED APPLICATION(S)

This application is a continuation of pending U.S. application Ser. No. 11/486,927 filed on Jul. 14, 2006, the disclosure of which is incorporated herein by reference. U.S. application Ser. No. 11/486,927 claims the benefit of U.S. Provisional Application Ser. No. 60/699,215, filed Jul. 14, 2005, the disclosure of which is incorporated by reference herein.

### FIELD OF THE INVENTION

The present invention relates to computer systems management, and more particularly, a global approach for computer systems management.

### BACKGROUND OF THE INVENTION

In a computer system, systems management is typically performed on a single set of homogenous resources, for example, on a tier of identical HTTP servers, a tier of identical application servers or a tier of identical database servers. As the size and heterogeneity of computer systems increases, the human effort required to coordinate the local management of these several heterogeneous subsystems to achieve a desired global behavior becomes increasingly difficult. Thus, an automated mechanism for coordinating the local management of these subsystems is required to ensure effective global management of the system as a whole.

In a large organization utilizing computers, such as, for example, enterprise computing systems, transactions may flow through many subsystems before completing. As a result, each subsystem plays a partial role in the success or failure of every transaction. Many of these subsystems have the ability to prioritize the work they receive, providing administrators with means to achieve subsystem goals. However, each individual subsystem has only a limited understanding of the system state, and moreover, their ability to prioritize work within their own domain provides only limited control of the overall system state. Thus, attainment of complete end-to-end transactional goals is difficult.

WebSphere Extended Deployment (XD), an IBM Corp. middleware system, manages parameters that affect the performance contribution by the tier that it controls, such as, for example, routing, CPU and memory allocation, and software module placement in the application tier of multi-tiered application environments. However, such a system is unable to control the other tiers, and therefore cannot contribute to the larger end-to-end response time goals for the system as a whole.

Accordingly, an improved approach of globally managing a system as a whole through coordinated local management is needed.

### SUMMARY OF THE INVENTION

In accordance with the aforementioned and other objectives, the present invention is directed towards techniques for global systems management.

In accordance with one aspect of the invention a method of globally managing systems is provided. One or more measurable effects of at least one hypothetical action to achieve a management goal are determined at a first system manager. The one or more measurable effects are sent from the first system manager to a second system manager. At the second system manager, one or more procedural actions to achieve the management goal are determined in response to the one or more received measurable effects. The one or more procedural actions are executed to achieve the management goal.

In illustrative embodiments of the present invention, the first and second system managers may be on the same or different hierarchical levels. The second system manager may request the first system manager to perform the step of determining measurable effects. The request may include a query message, having at least one hypothetical action and one or more corresponding effects to be measured. Additionally, the first system manager may submit a request to a third system manager to determine one or more measurable effects of the at least one hypothetical action to achieve a management goal.

In accordance with additional aspects of the present invention, the steps of determining and sending measurable effects may be repeated for at least one additional system manager. Further, the one or more procedural actions to achieve the management goal may be displayed to an administrator, and the administrator may select at least one of the one or more procedural actions for execution.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating communication within a multiple resource system, according to an embodiment of the present invention;

FIG. 2 is a diagram illustrating communication between system managers on the same hierarchical level, according to an embodiment of the present invention;

FIG. 3 is a diagram illustrating communication within a subsystem, according to an embodiment of the present invention;

FIG. 4 is a flow diagram illustrating a global systems management methodology, according to an embodiment of the present invention; and

FIG. 5 is a diagram illustrating an illustrative hardware implementation of a computing system in accordance with which one or more components/methodologies of the present invention may be implemented, according to an embodiment of the present invention.

### DETAILED DESCRIPTION OF THE INVENTION

As will be illustrated in detail below, the present invention introduces techniques for global systems management through coordinated local systems management. More specifically, an embodiment of the present invention entails exchange of what-if information in response to flexible queries among two or more individual systems, neither of which may or may not fully know or control the state of the system as a whole. The embodiments of the present invention apply to many different arrangements of systems. The invention will be illustrated herein in conjunction with an exemplary system for globally managing a computer system.

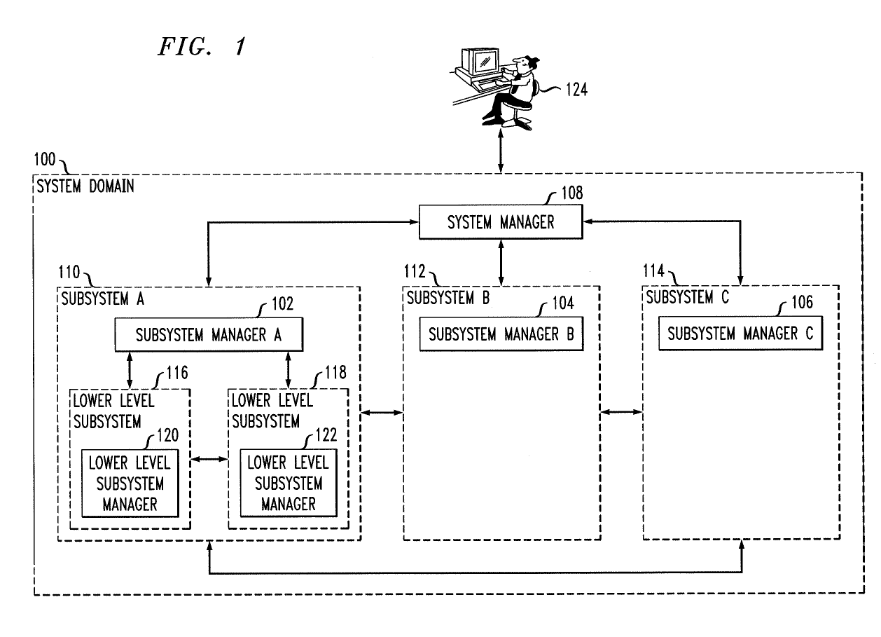

Referring initially to FIG. 1, a diagram illustrates a multiple resource system, according to an embodiment of the present invention. The system contains three resource-specific subsystem managers, subsystem manager A 102, subsystem manager B 104 and subsystem manager C 106, that cooperate with a system manager 108 to manage corresponding subsystems, subsystem A 110, subsystem B 112, and subsystem C 114, in a management hierarchy. Subsystem A 110, subsystem B 112, and subsystem C 114 may be any type of resource layer, such as, for example, a network resource, a database resource, a cache resource, or a provisioned server resource. The individual subsystem managers are responsible for exploiting resources within that subsystem in accordance with defined rules or goals for that subsystem. The individual subsystems typically do not have complete information about the state of the entire system, and they can only control a limited subset of the resources of the entire system, yet their individual actions can have an impact upon one another.

System manager 108 has access to controls for each of subsystem manager A 102, subsystem manager B 104, and subsystem manager C 106, such as, how subsystem A 110, subsystem B 112, and subsystem C 114 allocate memory, CPU, and other resources to different groups of requests. The controls could be low-level tuning parameter settings that entail prioritizing work, dynamically allocating shares of memory or CPU to different processes or service classes, or throttling certain classes of service requests to affect the relative rate at which work is done. Alternatively, the controls may be expressed as goals, such as response-time targets that would drive self-managing behavior of subsystem A 110, subsystem B 112 and subsystem C 114. The grouping of requests may, for example, be based upon the identity of the customer issuing the request, or may be associated with an expected quality of service, such as, for example, a response time guarantee for that group.

Each subsystem may also include lower level subsystems and lower level subsystem managers. For example, as shown in FIG. 1, subsystem A 110 includes a first lower level system 116 and a second lower level subsystem 118, each with corresponding first lower level subsystem manager 120 and second lower level subsystem manager 122.

In an embodiment of the present invention, system manager 108 requests from each of the subsystem manager A 102 and subsystem manager B 104 estimates of how changes in their control settings would affect service attributes of interest, such as, for example, throughput, response time, cost, profit, and net utility functions. For example, system manager 108 may ask subsystem manager A 102 and subsystem manager B 104, having three service classes, for estimates of the mean and variance of each service class given a proposed control setting change. Subsystem manager A 102 and subsystem manager B 104 would then send estimates to system manager 108. Upon receiving the estimates, system manager 108 may then perform a simple combinatorial optimization to identify a set of control settings for subsystem A 110 and subsystem B 112 that would maximize a global system objective, such as, for example, maximizing the likelihood that the total system response time added across the subsystems will not exceed an established threshold. System manager 108 would then set the control settings on subsystem manager A 102 and subsystem manager B 104 to this identified set of best control settings for subsystems A 110 and subsystem B 112, respectively.

Subsystem manager A 102 and subsystem manager B 104 may also send system manager 108 additional layer-specific data about the current state, such as, for example, the volume of requests, the current CPU and memory utilization, queue sizes and delays, and other system metrics. This additional information would potentially improve the ability of system manager 108 to find the optimal control settings for management of subsystem A 110 and subsystem B 112.

System manager 108 may reallocate servers from one subsystem manager to another in an effort to rebalance computing power as the workload within each subsystem fluctuates. When system manager 108 wishes to reconsider its allocation of n servers across subsystem A 110 and subsystem B 112, it sends a query to subsystem manager A 102 and subsystem manager B 104 in which a set of hypothetical actions is proposed explicitly in the query message. The hypothetical actions may consist of allocating n servers to one of the subsystem managers, for example, subsystem manager A 102, where n runs over some range that includes the current allocation. The service attribute of interest, which is described explicitly in the query message, is the expected utility that will be experienced by subsystem manager A 102 if it is granted n servers. Subsystem manager A 102 and subsystem manager B 104 compute an estimate of the value of the service attribute under each of the hypothetical actions, and send back a response to system manager 108. Each estimate computed by subsystem manager A 102 and subsystem manager B 104 is associated clearly with its pertinent hypothetical actions and service attribute. If a subsystem manager is not able to compute all of the requested estimates, it simply includes the ones it has successfully computed.

Optionally, the estimates may include indications of the degree of uncertainty in the estimates, for example, as variances or some other moments or representations of the statistical distribution of estimated outcomes. Upon receiving the estimates from subsystem manager A 102 and subsystem manager B 104, system manager 108 solves a combinatorial optimization problem in order to find the allocation that maximizes the utility summed over subsystem manager A 102 and subsystem manager B 104. Upon computing the allocations that provide the best overall utility, system manager 108 automatically takes corresponding action.

In another embodiment of the present invention, system manager 108 may display the allocations that it deems best to an administrator 124, allowing administrator 124 to select the most desirable allocation. In order to make an informed choice, administrator 124 may desire further information about the different allocation scenarios. For example, administrator 124 may request the average response times for each application according to service class. In such a case, system manager 108 can issue another query to subsystem manager A 102 and subsystem manager B 104, in which the hypothetical actions listed in the query message are the proposed allocations, and the service attributes of interest listed in the message would be the average response times rather than the utility values. Upon receiving this information from subsystem manager A 102 and subsystem manager B 104, system manager 108 may collate and display the results to administrator 124.

In accordance with another embodiment of the present invention, subsystem manager B 104, in response to a query from system manager 108, may query subsystem manager C 114 and incorporate the second query response into a response to the first query. For example, a system domain 100 which is represented as a two-tier web environment, in which subsystem A 110 is an application tier and subsystem B 112 is a database tier, with corresponding application tier manager 102 and database tier manager 104, respectively, independently optimizing their tiers. System manager 108, which understands the end-to-end system goals, could ask application tier manager 102 and database tier manager 104 a question in an effort to determine a set of changes that would best satisfy the end-to-end goals. For example, system manager 108 may query application tier manager 102 and database tier manager 104 the likely effect on tier response times of raising or diminishing the importance level of each service class by one degree from its present value.

In order to respond to the query from system manager 108, database tier manager 104, which understands the mapping of database tables to system files, may send a query to storage manager, represented as subsystem manager C 106, asking how the I/O response time for service classes would be affected if the I/O response-time target for a specific class were reduced from its present value of 2.0 seconds down to 1.0, 1.4, or 1.8 seconds. Storage manager 106 would respond with estimates of the likely impact on the I/O response times of all service classes. Taking this information into account along with the response time goals database tier manager 104 has received from system manager 108, database tier manager 104 may decide that a storage response time goal of 1.4 seconds would provide the best compromise across service classes if it were to raise the importance level for a specific class by one degree, but that 1.0 seconds would be best if the importance level of the specific class were diminished by a degree. This information would be folded into database tier manager's 104 response to the query from system manager 108, and system manager 108 would then take into account this response as well as the response from application tier manager 102 to compute a best modification of tier-specific response time goals and priorities.

Once the best modification of response-time goals and priorities for the individual tiers is determined by system manager 108, system manager 108 would convey this decision to application tier manager 102 and database tier manager 104. Storage manager 106 would then use any means at its disposal to bring about the desired result. For example, storage manager 106 may increase the amount of cache devoted to database files associated with one class, at the expense of the amount of cache allocated to other classes.

In another embodiment of the invention, system manager 108 may desire an end-to-end systems management goal of 15 ms for a group of requests. System manager 108 measures the actual response time from end-to-end. System manager 108 obtains data from subsystem manager A 102, subsystem manager B 104, and subsystem manager C 106 to determine how to adjust the subsystem-specific response-time targets to satisfy the end-to-end response time target. Next, system manager 108 queries subsystem manager A 102, subsystem manager B 104, and subsystem manager C 106 to determine the effect of allocation changes to groups of requests. Subsystem manager A 102, subsystem manager B 104 and subsystem manager C 106 respond to the queries. System manager 108 then computes the set of allocations for subsystem A 110, subsystem B 112, and subsystem C 114 that would best meet the end-to-end response time goal, and sends a request to subsystem manager A 102, subsystem manager B 104, and subsystem C 106 to update its allocation accordingly.

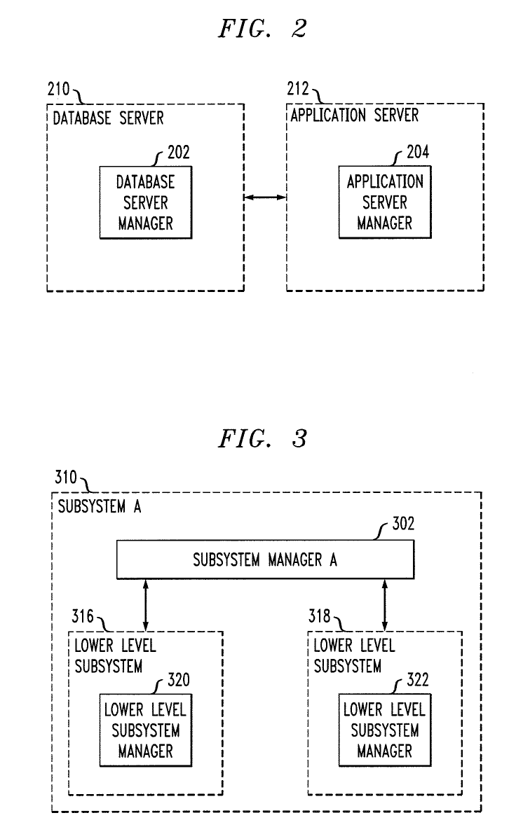

Referring now to FIG. 2, a diagram illustrates system manager communication on the same hierarchical level. More specifically, FIG. 2 illustrates communication between a database server manager 202 and an application server manager 204. This may be considered a specific example of communication between subsystem manager A 102 and subsystem manager B 104 in FIG. 1. Providing more resources to an application server 212 to improve response time may expose a database server 210 to a greater number of queries than it can handle, creating a bottleneck and decreasing the overall system response time. In order to avoid such a situation, database server manager 202 and application server manager 204 communicate with one another directly, without the involvement of a system manager. Application server manager 204 queries database server manager 202 for an estimate of the average response time that database server 210 would experience if application server manager 212 subjected database server 210 to a set of hypothetical query rates. Database server manager 202 would receive the query, and send its estimate back to application server manager 204. Application server manager 204 would then take into account the estimate of database server manager 202 in its own calculations, perhaps deciding to throttle the output of database server 210 to a level that provides the best estimated total response time through application server 212 and database server 210 combined.

Referring now to FIG. 3, a diagram illustrates communication within a subsystem, according to an embodiment of the present invention. Subsystem manager A 302 functions as a system manager for first lower level subsystem 316 and second lower level subsystem 318. Subsystem A 310 may have a quality of service objective expressed as a utility function in performance metrics, such as, for example, average response time, and other types of management metrics, such as, for example, recovery time or downtime. Subsystem manager A 302 may adjust its own internal parameters in order to maximize its utility function given its current resources. Subsystem manager A 302 would query first lower level subsystem manager 320 and second lower-level subsystem manager 322 within its domain. First lower level subsystem 316 and first lower subsystem manager 320 may comprise a lower level performance subsystem and manager, respectively, and second lower level subsystem 318 and second lower level subsystem manager 322 may comprise a lower level availability subsystem and manager, respectively. Lower level performance manager 320 and lower level availability manager 322 would respond to subsystem manager A 302 with estimates of effects upon response time and expected time-to-recover. Subsystem manager A 302 would then utilize these estimates in the utility function to identify a set of actions to be taken at its level that would maximize utility of subsystem A 310.

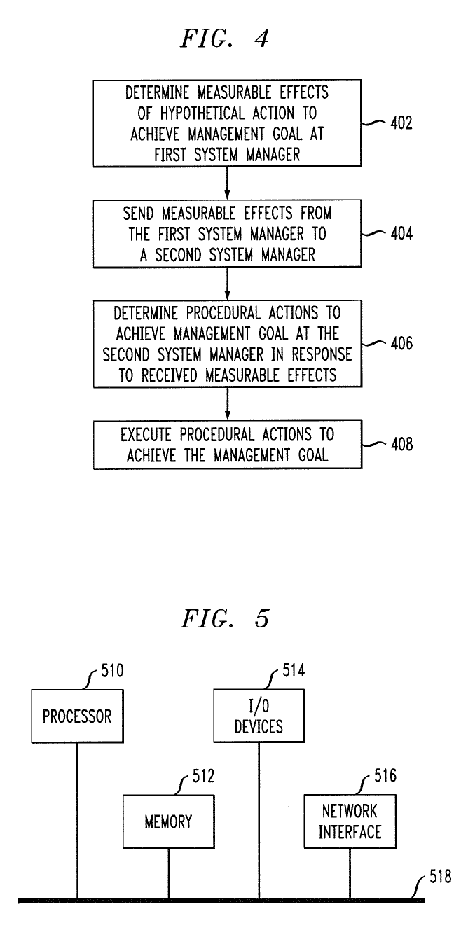

Referring now to FIG. 4, a flow diagram illustrates a global systems management methodology, according to an embodiment of the present invention. The methodology begins in block 402 where one or more measurable effects of at least one hypothetical action to achieve a management goal are determined at a first system manager. In block 404, the one or more measurable effects are sent from the first system manager to a second system manager. In block 406, one or more procedural actions to achieve the management goal are determined at the second system manager in response to the one or more received measurable effects. In block 408, the one or more procedural actions are executed to achieve the management goal, terminating the methodology.

Referring now to FIG. 5, a block diagram illustrates an exemplary hardware implementation of a computing system in accordance with which one or more components/methodologies of the invention (e.g., components/methodologies described in the context of FIGS. 1-4) may be implemented, according to an embodiment of the present invention.

As shown, the computer system may be implemented in accordance with a processor 510, a memory 512, I/O devices 514, and a network interface 516, coupled via a computer bus 518 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Still further, the phrase “network interface” as used herein is intended to include, for example, one or more transceivers to permit the computer system to communicate with another computer system via an appropriate communications protocol.

Software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for globally managing systems, the method comprising the steps of:
determining at a first system manager one or more measurable effects of at least one hypothetical action to achieve a management goal;
sending the one or more measurable effects from the first system manager to a second system manager;
determining at the second system manager one or more procedural actions to achieve the management goal in response to the one or more received measurable effects; and
executing the one or more procedural actions to achieve the management goal.

2. The method of claim 1, further comprising the step of repeating the steps of determining and sending measurable effects from at least one additional system manager.

3. The method of claim 1, wherein the first system manager and the second system manager are on the same hierarchical level.

4. The method of claim 1, wherein the first system manager and the second system manager are on different hierarchical levels.

5. The method of claim 4, wherein the first system manager comprises a subsystem manager and the second system manager comprises a system manager.

6. The method of claim 1, wherein the step of determining measurable effects is performed at the first system manager in response to a request from the second system manager.

7. The method of claim 6, wherein the request comprises a query message.

8. The method of claim 7, wherein the query comprises the at least one hypothetical action and one or more corresponding effects to be measured.

9. The method of claim 1, wherein the first system manager sends auxiliary data on a current state of a system managed by the first system manager to the second system manager.

10. The method of claim 9, wherein the auxiliary data comprises at least one of CPU utilization, memory utilization, CPU allocation shares, memory allocation shares, queue lengths, queuing delays, response times and throughput.

11. The method of claim 1, wherein, in the step of determining procedural actions, the second system manager uses an optimization method.

12. The method of claim 1, further comprising the step of displaying the one or more procedural actions to achieve the management goal to an administrator, wherein the administrator selects at least one of the one or more procedural actions for execution.

13. The method of claim 1, wherein the step of determining one or more measurable effects comprises the step of submitting a request from a first system manager to a third system manager to determine the one or more measurable effects of the at least one hypothetical action to achieve a management goal.

14. The method of claim 1, wherein the at least one hypothetical action comprises at least one of setting controls on prioritization, CPU allocation, memory allocation, rate control, throttling and goals.

15. The method of claim 1, wherein the one or more measurable effects comprise at least one of profit, cost, utility, response time, throughput, response down time, recovery time and data loss.

16. Apparatus for globally managing systems, comprising:
a memory; and
at least one processor coupled to the memory and operative to: (i) determine at a first system manager one or more measurable effects of at least one hypothetical action to achieve a management goal; (ii) send the one or more measurable effects from the first system manager to a second system manager; (iii) determine at the second system manager one or more procedural actions to achieve the management goal in response to the one or more received measurable effects; and (iv) execute the one or more procedural actions to achieve the management goal.

17. The apparatus of claim 16, wherein the at least one processor is further operative to repeating the operations of determining and sending measurable effects from at least one additional system manager.

18. The apparatus of claim 16, wherein the first system manager and the second system manager are on the same hierarchical level.

19. The apparatus of claim 16, wherein the first system manager and the second system manager are on different hierarchical levels.

20. An article of manufacture for globally managing systems, comprising a machine readable medium containing one or more programs which when executed implement the steps of:
determining at a first system manager one or more measurable effects of at least one hypothetical action to achieve a management goal;
sending the one or more measurable effects from the first system manager to a second system manager;
determining at the second system manager one or more procedural actions to achieve the management goal in response to the one or more received measurable effects; and
executing the one or more procedural actions to achieve the management goal.
